(19) United States
(12) Patent Application Publication
(10) Pub. No.: US 2006/0123044 A1
(43) Pub. Date: Jun. 8, 2006

(54) User interface device, printing device, and selective display method

(75) Inventor: Eiji Minami, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/291,898

(22) Filed: Dec. 2, 2005

(30) Foreign Application Priority Data
Dec. 2, 2004 (JP) 2004-349908

(51) Int. Cl. G06F 7/00

(52) U.S. Cl. 707/102

(57) ABSTRACT

A multifunction printer 10 comprises a reader/writer 16 connected readably/writably with a memory card 18 and an ink-jet printer mechanism 31. The memory card 18 stores a manifest as a control file including metadata. The manifest includes: link information to another manifest; album information capable of specifying an album as a collection of files having a predetermined relationship; and file information capable of specifying a file not included in any album but existing separately. Then, when selecting a file, the printer 10 organizes separate file information, and then gives a general name to the organized separate file information to display a link name, album name, and the general name selectably on a display unit 42. This allows the files to be displayed easily and selectably without complex management.

### BACKGROUND OF THE INVENTION

1. Field of the Invention

The present invention relates to a user interface device, a printing device, and a selective display method.

2. Description of the Prior Art

There has conventionally been proposed a user interface device that displays a plurality of files as one group for allowing the selection of a file (refer to Japanese Published Unexamined Patent Application No. 2004-171053 (FIG. 12), for example). The device described in Japanese Published Unexamined Patent Application No. 2004-171053 automatically groups files that meet a predetermined condition (e.g. the next file has been recorded within 1 hour after the previous file). Also, a playlist separately is prepared and registered as data for files that do not meet the predetermined condition but can prepare a playlist therefor. The group and the playlist are then managed by a display list, and when selecting a file to be reproduced, ones that meet the predetermined condition are thumbnailed as a group, while ones that do not meet the predetermined condition are listed or thumbnailed separately. Thus, since the number of files to be displayed is reduced compared to the case where many files are thumbnailed separately, it is easy to select a file.

However, in accordance with the user interface device described in Japanese Published Unexamined Patent Application No. 2004-171053, it is necessary to check the attributes of separate files that do not meet a predetermined condition to prepare a playlist for files having the same attribute, and then to store the playlist as data. That is, in addition to a display list for managing the entire file such as groups and separate files, data for managing separate files is required, resulting in complexity in managing files separately.

### SUMMARY OF THE INVENTION

The present invention has been made in consideration of the above-described problems, and an object thereof is to provide a user interface device, a selective display method, and a program therefor capable of displaying files easily and selectably without complex management.

In order to achieve the foregoing object, the present invention employs the following means.

The present invention is directed to a user interface device that includes a display unit for displaying an image, an information acquiring module, a general name giving module, and a display control module. In the user interface device, the information acquiring module acquires: at least one of either a group name given to group information adapted to organize one or more sets of file information having a predetermined relationship or a link name given to link information included in file management information that is prepared to allow the acquisition of file information and adapted to link the file management information with another file management information; and one or more sets of separate file information existing without being included in the group information. The general name giving module organize the one or more sets of separate file information acquired by the information acquiring module and for giving a general name to the organized one or more sets of separate file information. The display control module display the group name and/or the link name as well as the general name as a character, a figure, or a symbol that can be selected by a user on the display unit.

The user interface device is adapted to acquire at least one of either the group name or the link name as well as the separate file information, to give the general name for organizing the separate file information to the organized separate file information, and to selectably display at least one of either the group name or the link name as well as the general name. Thus, since the general name is given to the organized separate file information to be displayed, it is possible to display the files easily and selectably without complex management compared to one that utilizes management information for managing separate files.

In the user interface device of the invention, the information acquiring module may acquire the group name and/or the link name as well as the separate file information from file management information including: at least one of either the group information or the link information; and the separate file information.

In the user interface device of the invention, the general name giving module may give the same general name to any organized separate file information.

In the user interface device of the invention, the file information may be metadata of the files. In this case, it is preferable that the file information is described using markup language. Examples of markup language include XML, HTML, and SGML.

The user interface device of the invention may further include: a selective instruction acquiring module for acquiring an instruction of selecting any of the information displayed on the display unit from a user; and a file reading module for reading the contents of files included in the information selected by the selective instruction acquiring module when the information includes only file information. In this case, the user interface device may further include a file analyzing module for analyzing whether or not an image file is included among the files read by the file reading module, and the display control module may thumbnail the image file on the display unit when the file analyzing module analyzes that the image file is included.

The user interface device of the invention may further includes file classifying module for classifying the separate files based on a file name included in the separate file information, and the general name giving module may give a general name to each group of files classified by the file classifying module. Here, the “file name” includes the extension of the file. In this case, the file classifying module may classify files that include an extension belonging to the same category as the file name into the same type, while the general name giving module may give a general name including the category to a group of files that include an extension belonging to the same category. Also, the file classifying module may classify files including the same extension as the file name into the same type, while the general name giving module may give a general name including the extension to a group of files including the same extension.

The present invention is also directed to a printing device including: the user interface device described above; and a printing unit for printing an image included in a file selected by the user interface device on a recording medium using coloring agent.

The present invention is further directed to a selective display method using a display unit for displaying an image, which includes the steps of: (a) acquiring: at least one of either a group name given to group information adapted to organize one or more sets of file information having a predetermined relationship or a link name given to link information included in file management information that is prepared to allow the acquisition of file information and adapted to link the file management information with another file management information; and one or more sets of separate file information existing without being included in the group information; (b) organizing the one or more sets of separate file information acquired in the step (a) and giving a general name to the organized one or more sets of separate file information; and (c) displaying the group name and/or the link name acquired in the step (a) as well as the general name given in the step (b) as a character, a figure, or a symbol that can be selected by a user on the display unit.

In the selective display method of the invention, the step (a) may acquire the group name and/or the link name as well as the separate file information from file management information including: at least one of either the group information or the link information; and the separate file information.

In the selective display method of the invention, the step (b) may give the same general name to any organized separate file information.

In the selective display method of the invention, the file information may be metadata of the files. In this case, it is preferable that the file information is described using markup language.

The selective display method of the invention may further include the steps of: (d) acquiring an instruction of selecting any of the information displayed on the display unit in the step (c) from a user; and (e) reading the contents of files included in the information selected in the step (d) when the information includes only file information. In this case, the selective display method may further include the steps of: (f) analyzing whether or not an image file is included among the files read in the step (e); and (g) thumbnailing the image file on the display unit when the step (f) analyzes that the image file is included.

The selective display method of the invention may further include the step of: (h) classifying the separate files based on a file name included in the separate file information acquired in the step (a). Here, the step (b) may give a general name to each group of files classified in the step (h).

The present invention is also applicable as a program that allows one or more computers to execute each step of the foregoing selective display method. The program may be recorded on a computer-readable recording medium (e.g. hard disk, ROM, FD, CD, DVD), may be distributed from one to another computer via a transmission medium (communications network such as the Internet or LAN), or may be transferred to any other system. Executing the program on a computer or distributing and executing on a plurality of computers allows each step of the foregoing selective display method to be executed, resulting in the same effect as employing the foregoing selective display method.

### BRIEF DESCRIPTION OF THE DRAWINGS

FIG. 1 is a block diagram of a multifunction printer 10 according to the present embodiment;

FIG. 2 is an illustrative view of a control panel 40 according to the embodiment;

FIG. 3 is an illustrative view of description examples of manifests according to the embodiment, where FIG. 3(a) shows a description example of a root manifest 61 and FIG. 3(b) shows a description example of a manifest 71 linked to the root manifest 61;

FIG. 4 is a conceptual diagram of a manifest stored in a memory card 18 according to the embodiment;

FIG. 5 is a flow chart of a selective display control routine according to the embodiment;

FIG. 6 is an illustrative view of giving a general name in accordance with the embodiment;

FIG. 7 is an illustrative view of path information 14c to be stored in a RAM 14 according to the embodiment;

FIG. 8 is an illustrative view of selection screens 80 to 82 according to the embodiment, where FIG. 8(a) illustrates the selection screen 80, FIG. 8(b) illustrates the selection screen 81 after selecting an item on the selection screen 80, and FIG. 8(c) illustrates the selection screen 82 after selecting an item on the selection screen 81; and

FIG. 9 is a flow chart of an error-handling routine according to the embodiment.

### DESCRIPTION OF THE PREFERRED EMBODIMENTS

The best modes for carrying out the present invention will be described with reference to an embodiment.

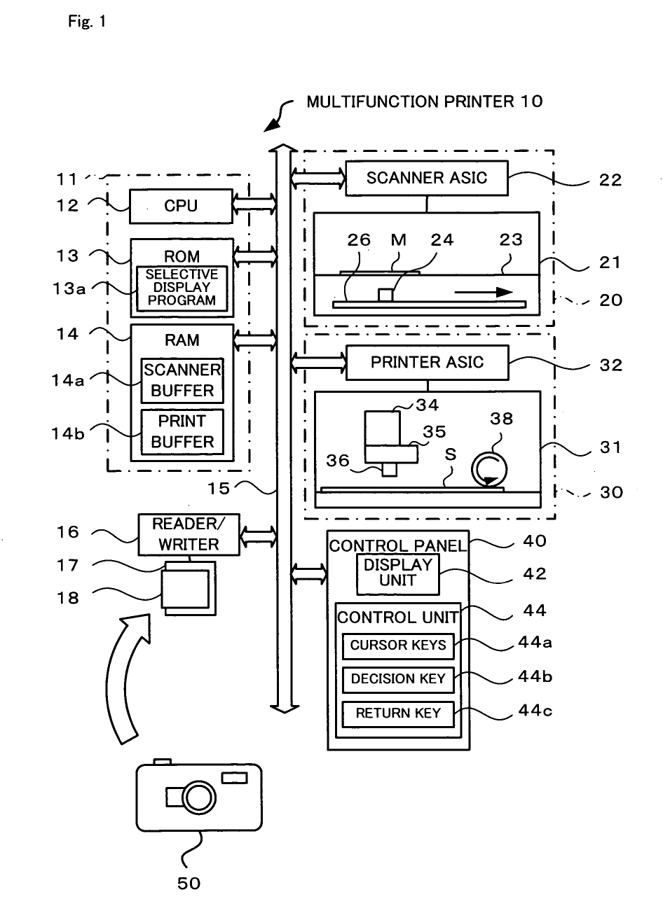

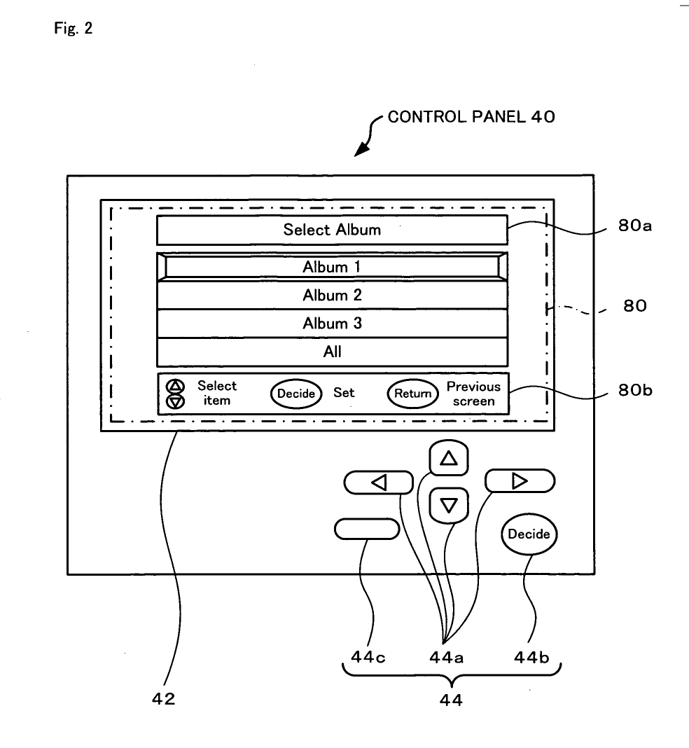

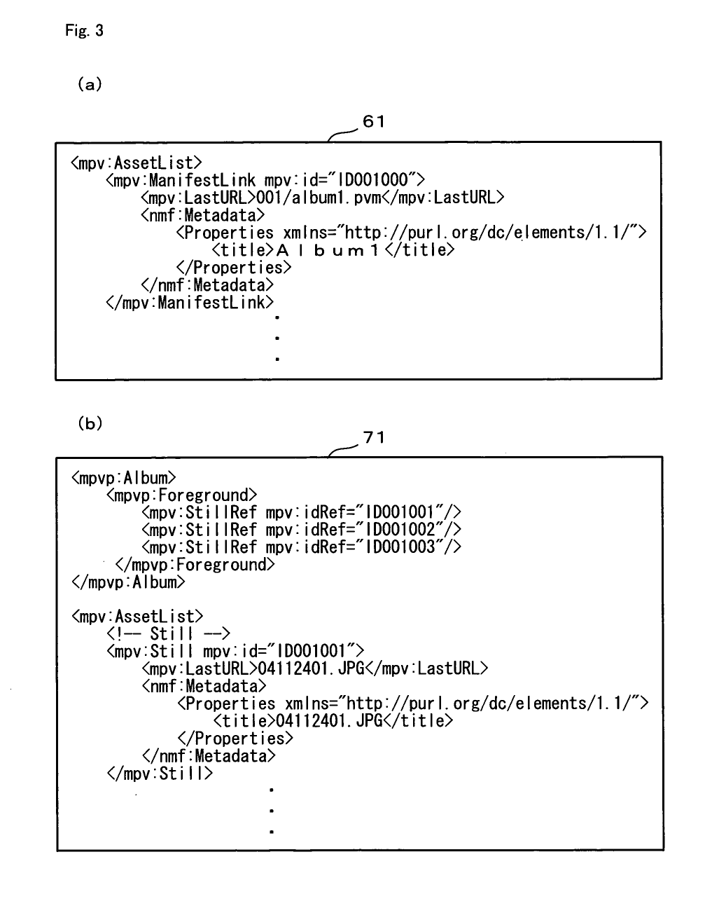

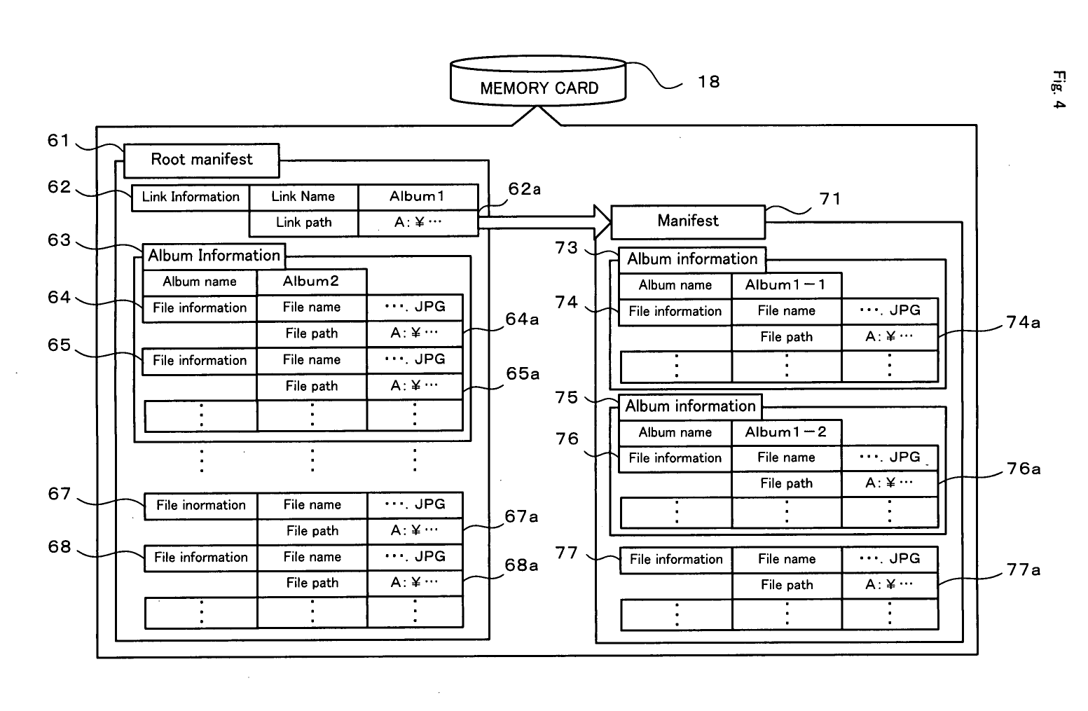

FIG. 1 is a block diagram of a multifunction printer 10 according to an embodiment of the present invention; FIG. 2 is an illustrative view of a control panel 40; FIG. 3 is an illustrative view of manifests stored in a memory card 18, where FIG. 3(a) shows a description example of a root manifest 61 and FIG. 3(b) shows a description example of a manifest 71 linked to the root manifest 61; and FIG. 4 is a conceptual diagram of a manifest stored in the memory card 18. As shown in FIG. 1, the multifunction printer 10 includes: a reader/writer 16 connected readably/writably with the memory card 18 that is inserted in a slot 17; a scanner section 20 including a scanner mechanism 21 for performing scanner functions and a scanner ASIC 22 for controlling the scanner mechanism 21; a printer section 30 including a printer mechanism 31 for realizing printer functions and a printer ASIC 32 for controlling the printer mechanism 31; a control panel 40 with which a user inputs various kinds of commands; and a controller 11 for entirely controlling the device. It is noted that “ASIC” is an abbreviation for Application Specific Integrated Circuit.

The scanner section 20 includes the scanner mechanism 21 and the scanner ASIC 22. The scanner mechanism 21 is a so-called flatbed one, and includes: a glass surface 23 for mounting a medium M to be scanned; a line image sensor 24 for optically scanning the medium M via the glass surface 23; and a moving member 26 for running the line image sensor 24 to scan the medium M. The scanner ASIC 22, which is an IC chip having a function of controlling the scanner mechanism 21, stores scan data scanned by the line image sensor 24 of the scanner mechanism 21 in a scanner buffer 14a provided in a RAM 14 of the controller 11. The line image sensor 24 according to the present embodiment is a well-known color image sensor for splitting light applied to and reflected from the medium M into each color of red (R), green (G), and blue (B) as scan data.

The printer section 30 includes the printer mechanism 31 and the printer ASIC 32. The printer mechanism 31 is constructed as an ink-jet full-color printer. The printer mechanism 31 includes: an ink cartridge 34 separately housing each color ink of cyan, magenta, yellow, light cyan, light magenta, and black; a pressure generating member 35 for applying pressure to each ink supplied from the ink cartridge; a discharge port 36 for discharging ink pressurized in the pressure generating member 35 onto recording paper S as a printing medium; and a carrier roller 38 for carrying the recording paper S. The pressure generating member 35 employs a system of applying a voltage to a piezoelectric element to be deformed and thereby pressurizing ink. It is noted that the pressure generating member 35 may employ a system of applying a voltage to a heat element (e.g. heater) to heat ink and thereby pressurizing the ink using generated bubble. The printer ASIC 32 is an IC chip having a function of controlling the printer mechanism 31, and controls the printer mechanism 31 in such a manner as to develop print data in a print buffer 14b provided in the RAM 14 into a bitmap image by one page, and then to print the developed data on the recording paper S.

The control panel 40 is a device for allowing a user to input various kinds of commands into the multifunction printer 10, the control panel including a display unit 42 for displaying characters, figures, or symbols according to various kinds of commands and a control unit 44 for various kinds of controls as shown in FIG. 2. The display unit 42 is composed of a liquid crystal panel for displaying a color image. It is noted that the selection screen 80 will be described in detail later. On the control unit 44 are arranged: cursor keys 44a to be pressed when a user moves a cursor for selecting processing, etc.; a decision key 44b to be pressed when deciding the selection of processing; and a return key 44c to be pressed when returning the screen displayed on the display unit to the previous screen.

The reader/writer 16 reads/writes data from/into the memory card 18 inserted in the slot 17 provided in the chassis of the multifunction printer 10. The memory card 18 is an electrically rewritable flash memory and stores image files, etc., taken with a digital camera 50. Here, image files taken by a user are stored in MPV (Music Photo Video) format. MPV is a standard that defines the specification of metadata for describing the details of contents. As shown in FIG. 3, MPV uses a manifest, the details of which being described using XML as a markup language, as a control file. The manifest describes metadata such as information of supported file formats, file names stored in the memory card 18, and file paths for specifying the memory location of files. Therefore, the multifunction printer 10 can easily recognize where and what kinds of files are stored in the memory card 18 by reading and analyzing the manifest without reading each file itself.

The manifest stored in the memory card 18 will here be described with reference to FIG. 4. The root manifest 61 is a manifest to be first read by the controller 11 when the insertion of the memory card 18 is recognized. The root manifest 61 includes: link information 62 to another manifest 71; album information 63 capable of specifying an album as a collection of files having a predetermined relationship such as being taken in the same event (e.g. athletic meet) or being taken on the same date; and file information 67 and 68, etc., capable of specifying a file not included in any album but existing separately. Here, file means a separate collection of data, etc., while file information means data capable of specifying a file such as file name and file path. Also, album means a conceptual collection of one or more files, while album information means information capable of specifying an album such as album name, the name of a file included in the album, and the file path of the file included in the album. The link information 62 includes Album1 as a link name and a link path 62a that indicates the location where the linked manifest 71 is stored. The album information 63 includes Album2 as an album name and file information 64 and 65, etc., included in the album. The file information 64 includes a file name and a file path 64a, while the file information 65 includes a file name and a file path 65a. The separate file information 67 includes a file name and a file path 67a, while the separate file information 68 includes a file name and a file path 68a. It is noted that the root manifest 61 may include other link information and/or other album information. The root manifest 61 also includes another album information, not shown in the figure, having an album name of Album3. In addition, manifests to be used in the multifunction printer 10 are arranged in such a manner that no album information has further album information (i.e. sub-album) therebelow.

The manifest 71 is linked with the root manifest 61 via the link information 62. The manifest 71 includes album information 73 and 75 and file information 77 capable of specifying a file not included in any album but existing separately. The album information 73 includes Album1-1 as an album name and file information 74, etc., of files included in the album. The file information 74 includes a file name and a file path 74a. Also, the album information 75 includes Album1-2 as an album name and file information 76, etc., of files included in the album. The file information 76 includes a file name and a file path 76a. The file information 77 includes a file name and a file path 77a. It is noted that the manifest 71 may include other link information and/or other album information.

The controller 11 is constructed as a microprocessor mainly having a CPU 12 (refer to FIG. 1), and includes a ROM 13 with various kinds of processing programs stored therein and the RAM 14 for storing and saving data temporarily. The controller 11 is connected to the reader/writer 16, the scanner ASIC 22, the printer ASIC 23, and the control panel 40 via a bus 15. The ROM 13, which is a non-volatile storage device, stores a selective display control program 13a to be executed when selecting a file stored in the memory card and programs for various kinds of controls. The RAM 14 includes a plurality of areas including the scanner buffer 14a for temporarily storing image information scanned by the scanner section 20 and the print buffer 14b for temporarily storing image information to be printed by the printer section 30.

The description now regards the operation of the thus arranged multifunction printer 10 according to the present embodiment, and particularly the operation when a user selects a file stored in the memory card 18 and when the multifunction printer 10 prints the selected file.

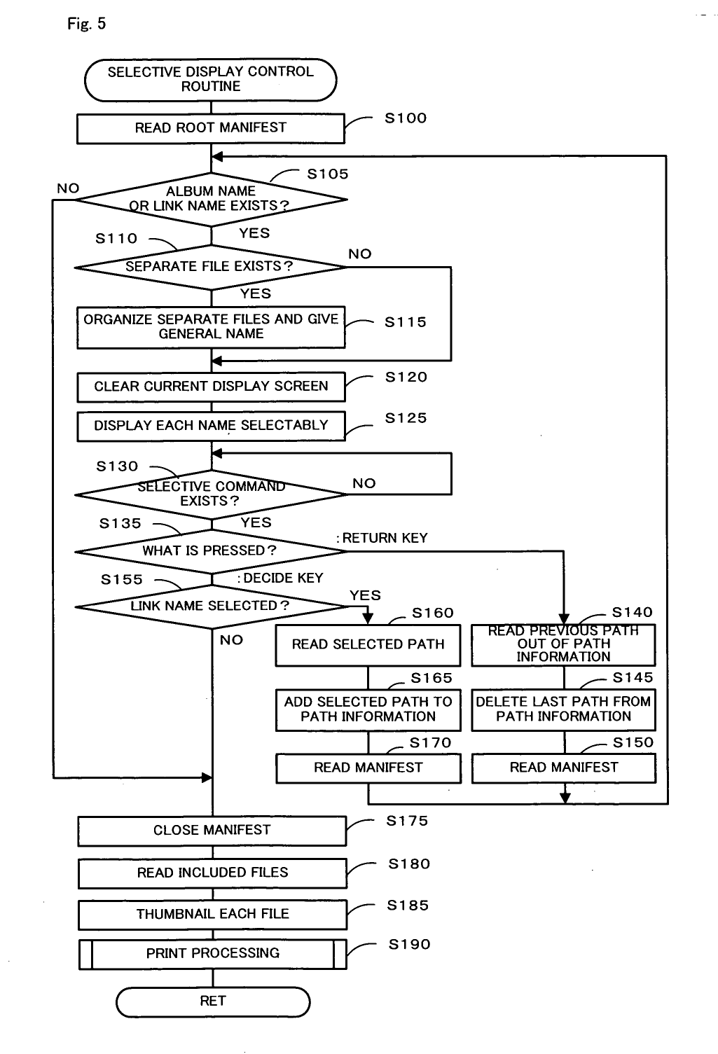

FIG. 5 is a flow chart of a selective display control routine to be executed by the CPU 12 in the controller 11. The routine is stored in the ROM 13 and is to be executed by the CPU 12 when the user has inserted the memory card 18 into the slot 17 of the reader/writer 16 and then selected print processing from the menu screen. When the routine shown in FIG. 5 is started, the CPU 12 reads a root manifest out of the memory card 18 (step S100). To be more concrete, the number of album information, the name of each album, the number of links to other manifests, the name of each link, the number of separate files not included in any album, and the name of each file included in the root manifest are to be read. Here, as shown in FIG. 4, one piece of link information 62, two pieces of album information, and two pieces of separate file information 67 and 68, and further a link name of Album1 as well as album names of, respectively, Album2 and Album3 are read out.

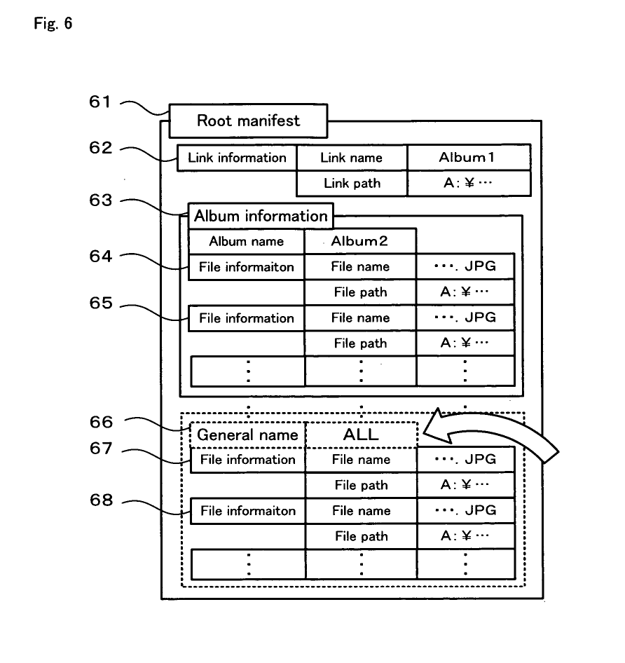

Next, the CPU 12 determines whether or not the read manifest includes at least one of either an album name or a link name (step S105). That is, the CPU determines whether or not there is an alternative superior to a file (the location where to put files collectively, e.g. folder), which it self is not a file. When the manifest includes at least one of either an album name or a link name, it is determined whether or not the manifest includes one or more sets of separate file information existing without being included in any album information (step S110). When the manifest includes one or more sets of separate file information, the CPU 12 organizes the one or more sets of separate file information, and then gives a general name to the organized separate file information as shown in FIG. 6 (step S115). The multifunction printer 10 is here adapted to always give a name “ALL” as a general name 66 for organizing all the separate file information. It is noted that “organizing separate file information” means not an actual collecting operation, for example, of forming something like a folder and then moving or copying file information included in a manifest to the folder, but organizing separately existing file information by relating to a general name. The same also applies to a file, and no operation of forming a folder and then moving or copying information will be performed. Then, after step S115 or when the manifest includes no separate file in step S110, the CPU 12 clears the current display screen (step S120), and then allows the display unit 42 to selectably display the link name and the album name read in step S100 and the general name given in step S115 (step S125).

In the selection screen 80 to be displayed on the display unit 42, rectangular blocks with the link name Album1 and the album names Album2 and Album3 read in step S100 as well as the general name ALL respectively put therein are to be arranged vertically. In the selection screen 80, a processing display field 80a for displaying the current processing is arranged above the rectangular blocks, while an operation method display field 80b is arranged below the rectangular blocks. In the selection screen 80, since the general name is adapted to be arranged constantly in the bottom field of alternatives included in the manifest, users can recognize that there is no alternative below the general name. Also in the selection screen 80, the currently selected block is adapted to be displayed in a solid shape, and the solid-shaped block is to be moved upward with the pressing of the up key among the cursor keys 44a, while the solid-shaped block is to be moved downward with the pressing of the down key among the cursor keys 44a. It is noted that giving a name “Album1” like an album name to the link name, which is a name that indicates a linkage to another manifest 71 (refer to FIG. 4), allows the screen to be displayed as if an album is to be selected. That is, the link name and the general name are displayed at the same level as the album names in the selection screen 80.

Then, after step S125, the CPU 12 determines whether or not the user has given a selective instruction (step S130). Here, the user looks at the contents on the selection screen 80, and then operates the cursor keys 44a, the decision key 44b, and the return key 44c to give a selective instruction. While no selective instruction is given, the CPU 12 stands by as it is. When a selective instruction is given, determines which of the decision key 44b or the return key 44c has been pressed (step S135). It is noted that in step S135 when the root manifest 61 is read (i.e. on the initial display screen), the return key 44c is adapted not to be pressed.

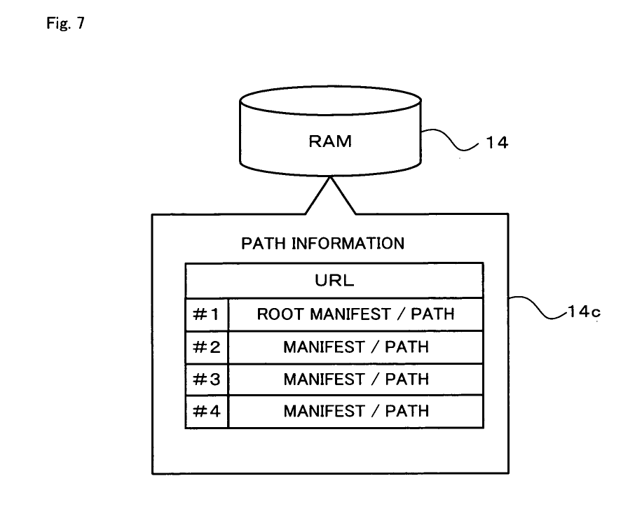

When the decision key 44b is pressed, the CPU 12 determines whether or not a link name is selected (step S155), and when a link name is selected, the CPU 12 reads the path selectively instructed by the decision key 44b (step S160), and then adds the path to the bottom field of path information 14c stored in the RAM 14 (step S165). Here, the path information 14c, which means information storing which path of what kind of manifest has been passed via the current selection screen 80 as shown in FIG. 7, is adapted to be prepared in the RAM 14 when starting the multifunction printer 10. The path information 14c is used to return to the previous display screen, and stores the path of the root manifest as an initial value. Then, after step S165, the CPU 12 reads the manifest corresponding to the read path, that is, the linked manifest (step S170), and then performs the processing of the foregoing steps S105 to S135.

Meanwhile, when the return key 44c is pressed in step S135, the CPU 12 reads the path written in the last field before the bottom one of the path information 14c (step S140), deletes the path written in the bottom field of the path information 14c (step S145), reads the manifest corresponding to the read path, that is, the previously displayed manifest (step S150), and then performs the processing of the foregoing steps S105 to S130. Utilizing the path information 14c allows the details of the manifest which are opened when advancing the selection to be cleared in step S120, and thus can avoid a reduction of resources.

When no link name is selected, that is, when an album name or a general name is selected in step S155, or when the manifest includes neither an album name nor a link name in step S105, since the currently selected information includes only file information and the user is to select a file itself, the CPU closes the currently opened manifest (step S175), and then reads a file included in the currently selected information (step S180). To be more concrete, when the currently selected manifest includes only separate file information, the CPU reads all file information included in the manifest, while when an album name is currently selected, reads all file information included in the album information, and while when a general name is currently selected, reads all separate file information included in the manifest. Reading file information means reading information such as file name, file format, and the existence of a thumbnail.

After step S180, the CPU 12 analyzes whether or not there is an image file among the read files, and when there is an image file, thumbnails each file (step S185). The image file may be a still image file or a video file. The vicinity of the thumbnail image may be displayed the file name of the file. Then, the user selects a certain file and gives a print instruction. The CPU 12 receives the print instruction given by the user, performs print processing for the selected image file (step S190), and then terminates the routine. It is noted that when a video file is selected, a stopped screen stopped randomly by the user via a control of the control unit 44 is to be printed. The printing operation of the multifunction printer 10 will be described. The controller 11 of the multifunction printer 10 gives a print command to the printer ASIC 32 after receiving a print instruction. After receiving the print command, the printer ASIC 32 drives a drive motor not shown in the figure to rotate the carrier roller 38 and thereby carry the recording paper S, and then controls the voltage applied to the pressure generating member 35 to print images included in the print data on the recording paper S.

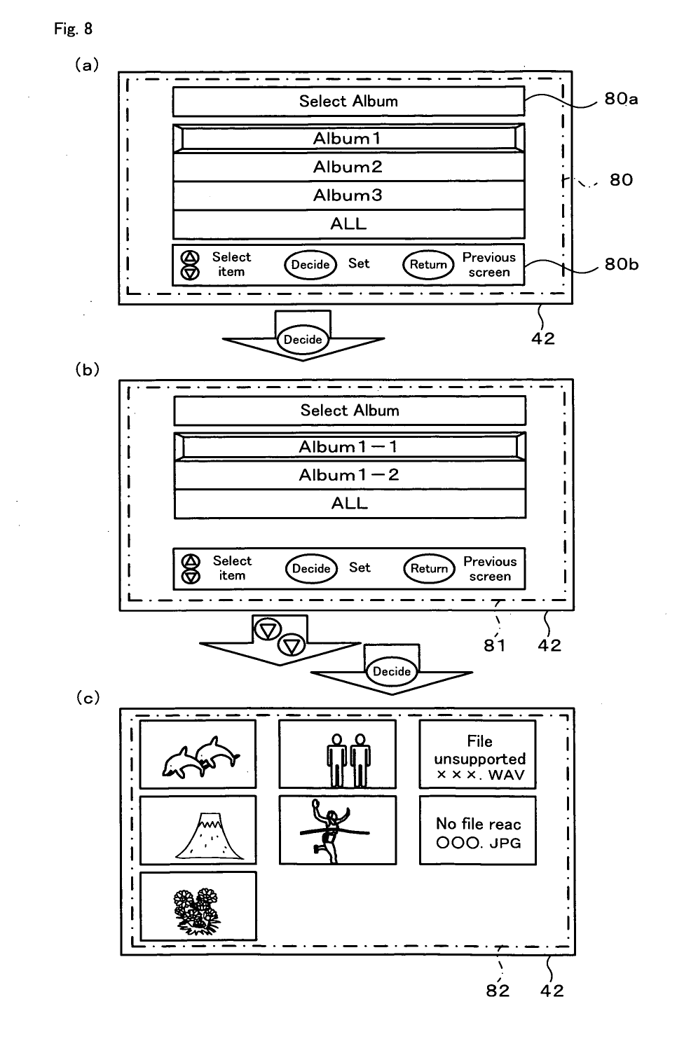

A series of operations for selecting a file will be described with reference to the illustrative view of a manifest shown in FIG. 4 and FIG. 8. FIG. 8 is an illustrative view of selection screens 80 to 82, where FIG. 8(a) illustrates the selection screen 80, FIG. 8(b) illustrates the selection screen 81 after selecting an item on the selection screen 80, and FIG. 8(c) illustrates the selection screen 82 after selecting an item on the selection screen 81. The user first inserts the memory card 18 into the multifunction printer 10, and then selects print processing in the menu screen. Then, the CPU 12 reads a root manifest 61 out of the memory card 18. Here is to be read that the root manifest 61 includes the link name of link information 62, the album name of album information 63, and separate file information 67 and 68, with a link name of Album1 as well as album names of Album2 and Album3. Since the root manifest 61 includes link information, album information, and separate file information, the CPU organizes the separate file information 67 and 68, and then gives a general name “ALL” to the organized separate files (refer to FIG. 6). Then, the CPU displays the selection screen 80, in which Album1 (link name), Album2, Album3 (album names), and ALL (general name) are arranged vertically in a selectable manner as shown in FIG. 8(a), on the display unit 42. Next, the user controls the control unit 44, while looking at the selection screen 80, to select Album1 and then presses the decision key 44b. Since the link name of the link information 62 shown in FIG. 4 is selectively instructed, the CPU 12 then reads the link path 62a to read the contents of the manifest 71. The manifest 71 includes Album1-1 and Album1-2 as the album names, respectively, of album information 73 and 75, and further separate file information 77. Thus, the CPU 12 organizes the separate file information 77, and then gives a general name “ALL” to the organized separate file information 77. Then, the CPU displays the selection screen 81, in which Album1-1, Album1-2 (album names), and ALL (general name) are arranged vertically in a selectable manner as shown in FIG. 8(b), on the display unit 42. Subsequently, the user presses the down key among the cursor keys 44a twice, while looking at the selection screen 81, to select ALL and then presses the decision key 44b. Then, since neither a link name nor an album name is included in the details of the selected general name, the CPU 12 closes the manifest 71, reads information such as file name, file format, and the existence of a thumbnail of all the separate file information 77, and then analyzes whether or not there is an image file among the read files. Next, the CPU 12 displays the selection screen 82, in which the thumbnails of the analyzed image files are arranged vertically and horizontally as shown in FIG. 8(c), on the display unit 42. Here, messages for files in unsupported formats and/or for unreadable files due to incorrect linkage are to be displayed accordingly on the corresponding thumbnails. Then, the user selects an image to be printed while looking at the thumbnails, and then gives a print command. The CPU 12 then prints the image file of the print command.

The correspondence of the components of the present embodiment to those of the present invention will here be made clear. The CPU 12 of the present embodiment corresponds to the information acquiring module, the general name giving module, the display control module, the file reading module, and the file analyzing module of the present invention; the control unit 44 to the selective instruction acquiring module; and the printer mechanism 31 to the printing unit. Also, the album information 63, 73 and 75 corresponds to the group information of the present invention; and the root manifest 61 and the manifest 71 to the file management information. It is noted that an example of the selective display method of the present invention is made clear by describing the operation of the multifunction printer 10 in the present embodiment.

The multifunction printer 10 of the present embodiment described above acquires an album name, a link name, and separate file information; gives a general name for organizing the separate file information to the organized separate file information; and selectably displays the general name, group name, and the link name. Thus giving a general name to organized separate file information and displaying the name allows the files to be displayed easily and selectably without complex management compared to one that utilizes management information for managing separate files. In addition, link names are also displayed, and selecting a link name allows album information and/or separate file information included in another manifest to be accessed via the link information, whereby users can easily find a required file.

Also, organizing separate file information and always giving the same general name “ALL” to the organized separate file information allows users to recognize easily that the general name is related to the separate file information glancing at the general name displayed on the display unit 42.

Further, since the file information is metadata of the files described using XML, high-speed processing can be achieved compared to the case where the controller 11 acquires a file itself. In addition, since the range of files required by a user is first narrowed using metadata included in the manifest, and then the files are to be read when selecting a file itself, further high-speed processing can be achieved. In this case, since when an image file is included among the read files, the image file is to be thumbnailed on the display unit 42, the user can easily select an image file.

Furthermore, since files required to be printed are often found by inserting the memory card 18 storing files to be printed into the multifunction printer 10, it is further significant to apply the present invention.

The present invention is not restricted to the above-described embodiment, and various modifications may be made without departing from the technical scope of the present invention.

In the above-described embodiment, the general name “ALL” for organizing all the separate file information is given to the separate file information. In one modification, the separate file information may be classified based on the category of the extension in a file name included in the separate file information, and then a general name relating to the category of the extension may be given to each group of the classified file information. To be more concrete, organizing file information having an extension of JPG, GIF, or BMP and giving a general name “separate still image file” thereto; organizing file information having an extension of AVI, MOV, or MPG and giving a general name “separate video file” thereto; and organizing file information having an extension of WAV, MP3, or MID and giving a general name “separate music file” thereto, these are arranged on the selection screen 80 selectable. Thus, since the general names are displayed by being classified into each category of the files, users can easily find a required file among the separate files. It is noted that file information including the same extension may be classified into the same group, and that a general name including the extension (e.g. “separate JPG file”) may be given to a group of file information including the same extension.

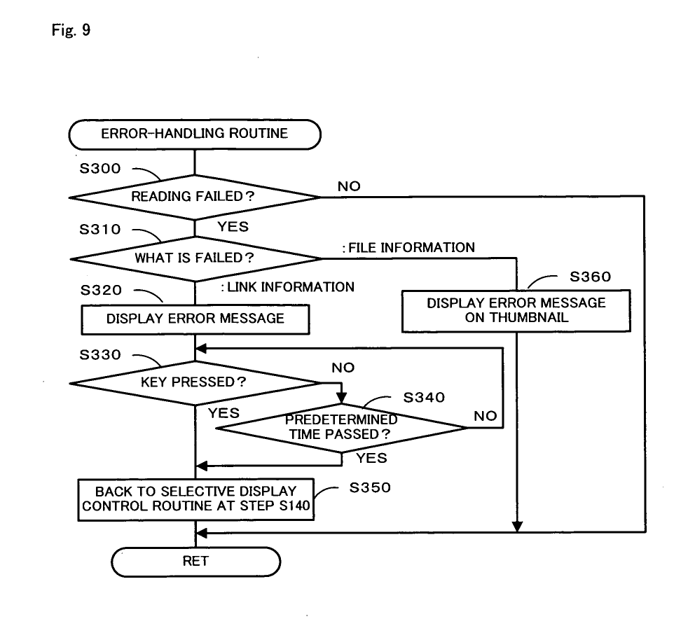

The following error handling may be performed, though not particularly described in the above-described embodiment, when the path of link information and/or file information included in the manifest is incorrect, for example, a file has been moved to another location other than the file path included in the file information. FIG. 9 is a flow chart of an error-handling routine. The routine is stored in the ROM 13, and is to be executed interrupting the selective display control routine after the multifunction printer 10 reads a manifest in steps S150 and S170 and reads a file in step S175. When the routine is executed, the CPU 12 determines whether or not the reading of the link of the selectively instructed path or the file fails (step S300). when the reading of the link of the selectively instructed path or the file does not fail, the CPU 12 releases the interruption to restart the selective display control routine, and then terminates the routine. Meanwhile, when the reading of the link of the selectively instructed path or the file fails, the CPU 12 determines which of link information or file information has a reading failure (step S310). When link information has a reading failure, the CPU displays an error message indicating that the linked manifest cannot be read and a message indicating the pressing of any button for confirmation on the display unit 42 (step S320). Then, the CPU 12 determines whether or not any button has been pressed (step S330), and when no button has been pressed, determines whether or not a predetermined time has passed (step S340), and when the predetermined time has not yet passed, performs the processing of step S330. Subsequently, when the predetermined time has passed or any button has been pressed in step S330, the CPU 12 restarts the selective display control routine from step S140 (step S350), and then terminates the routine. That is, after displaying confirmation for users, the CPU 12 automatically performs the processing when pressing the return key 44c (processing in steps S140 to S150 of the selective display control routine). Meanwhile, when file information has a reading failure in step S310, the CPU displays an error message indicating that no file can be read on a thumbnail to be displayed on the display unit 42 (step S360), and then terminates the routine. In this case, when the file having a failure in reading file information has a format not supported by the multifunction printer 10, the CPU displays a message accordingly, while when the file having a failure in reading file information does not exist in the file path (incorrect linkage), the CPU also displays a message accordingly. This allows an error message to be displayed on the display screen, whereby users can confirm that the path of link information and/or file information is incorrect. Also, when the path of link information is incorrect, it automatically returns to the previous screen, whereby users can avoid the trouble of pressing the return key 44c.

In the above-described embodiment, manifests are arranged in such a manner that no album information has further album information (i.e. sub-album) therebelow. There may be provided a sub-album and the following processing may be performed in step S155 of the selective display control routine. When the decision key 44b is pressed in step S135, the CPU determines which of general name, link name, or album name is selected, and when a general name is selected, performs the processing after step S175; when a link name is selected, performs the processing after step S160; and when an album name is selected, performs the processing after step S105. This allows album information to include sub-album information.

In the above-described embodiment, the multifunction printer 10 is constructed as an ink-jet full-color one. The printer may be an electrophotographic color laser one, a thermal transfer color one, or a dot impact one, or a black-and-while type one thereof. The printer also may be a printing device such as a fax machine or copy machine. The present invention may also be applied to an image processor such as a personal computer, scanner, digital camera, or digital video, and a music reproducer or a mobile phone such as a CD player, MD player, or MP3 player.

While the multifunction printer 10 in the above-described embodiment allows users to select an image file to be printed, a music file may be selected to be reproduced.

The present invention claims benefit of priority to Japanese Patent Application No. 2004-349908, filed on Dec. 2, 2004, the contents of which are incorporated by reference herein in their entirety.

What is claimed is:

1. A user interface device comprising:
a display unit for displaying an image;
an information acquiring module for acquiring: at least one of either a group name given to group information adapted to organize one or more sets of file information having a predetermined relationship or a link name given to link information included in file management information that is prepared to allow the acquisition of file information and adapted to link the file management information with another file management information; and one or more sets of separate file information existing without being included in the group information;
a general name giving module for organizing the one or more sets of separate file information acquired by the information acquiring module and for giving a general name to the organized one or more sets of separate file information; and
a display control module for displaying the group name and/or the link name as well as the general name as a character, a figure, or a symbol that can be selected by a user on the display unit.

2. The user interface device according to claim 1, wherein
the information acquiring module acquires the group name and/or the link name as well as the separate file information from file management information including: at least one of either the group information or the link information; and the separate file information.

3. The user interface device according to claim 1, wherein
the general name giving module gives the same general name to any organized separate file information.

4. The user interface device according to claim 1, wherein
the file information is metadata of the files.

5. The user interface device according to claim 4, wherein
the file information is described using markup language.

6. The user interface device according to claim 1, further comprising:
a selective instruction acquiring module for acquiring an instruction of selecting any of the information displayed on the display unit from a user; and
a file reading module for reading the contents of files included in the information selected by the selective instruction acquiring module when the information includes only file information.

7. The user interface device according to claim 6, further comprising
a file analyzing module for analyzing whether or not an image file is included among the files read by the file reading module,
wherein the display control module thumbnails the image file on the display unit when the file analyzing module analyzes that the image file is included.

8. The user interface device according to claim 1, further comprising
a file classifying module for classifying the separate file information based on a file name included in the separate file information,
wherein the general name giving module gives a general name to each group of files classified by the file classifying module.

9. A printing device comprising:
the user interface device according to claim 1; and
a printing unit for printing an image included in a file selected by the user interface device on a recording medium using coloring agent.

10. A selective display method using display unit for displaying an image, the method comprising the steps of:
(a) acquiring: at least one of either a group name given to group information adapted to organize one or more sets of file information having a predetermined relationship or a link name given to link information included in file management information that is prepared to allow the acquisition of file information and adapted to link the file management information with another file management information; and one or more sets of separate file information existing without being included in the group information;
(b) organizing the one or more sets of separate file information acquired in the step (a) and giving a general name to the organized one or more sets of separate file information; and
(c) displaying the group name and/or the link name acquired in the step (a) as well as the general name given in the step (b) as a character, a figure, or a symbol that can be selected by a user on the display unit.

11. The selective display method according to claim 10, wherein
the step (a) acquires the group name and/or the link name as well as the separate file information from file management information including: at least one of either the group information or the link information; and the separate file information.

12. The selective display method according to claim 10, wherein
the step (b) gives the same general name to any organized separate file information.

13. The selective display method according to claim 10, wherein
the file information is metadata of the files.

14. The selective display method according to claim 13, wherein
the file information is described using markup language.

15. The selective display method according to claim 10, further comprising the steps of:
(d) acquiring an instruction of selecting any of the information displayed on the display unit in the step (c) from a user; and
(e) reading the contents of files included in the information selected in the step (d) when the information includes only file information.

16. The selective display method according to claim 15, further comprising the steps of:
(f) analyzing whether or not an image file is included among the files read in the step (e); and
(g) thumbnailing the image file on the display unit when the step (f) analyzes that the image file is included.

17. The selective display method according to claim 10, further comprising the step of:
(h) classifying the separate files based on a file name included in the separate file information acquired in the step (a),
wherein the step (b) gives a general name to each group of files classified in the step (h).
